(19) United States
(12) Patent Application Publication
(10) Pub. No.: US 2010/0029372 A1
(43) Pub. Date: Feb. 4, 2010

(54) Methods and apparatus for a terminal network interface for use with wagering applications

(75) Inventor: Joseph Michael Bullock, Glyndon, MD (US)

Correspondence Address: Griffin & Leahy, LLC;Steven C. DeSmet, Suite 900, 11785 Beltsville Drive, Calverton, MD, 20705, US

(73) Assignee: AmTote International, Inc., Hunt Valley, MD (US)

(21) Appl. No.: 12/220,824

(22) Filed: Jul. 29, 2008

(51) Int. Cl. G06F 17/00; G06F 3/00

(52) U.S. Cl. 463/25; 710/72

(57) ABSTRACT

An improved system and method for the transmission of information between a plurality of wagering terminals (peripherals and other downstream devices) and a central wagering hub (processing center) for use in association with wagering and/or pari-mutuel wagering applications is herein disclosed.

### BACKGROUND OF THE INVENTION

1. Field of the Invention

The present invention relates to a communications concentrator/multiplexer and, more specifically, to a system and method for the safe, secure and reliable transmission of wagering and/or pari-mutuel wagering information between a Central Wagering Hub and a plurality of downstream devices through a Terminal Network Interface system.

2. Description of the Background

The present invention is generally related to wagering/gaming devices, wagering networks and more specifically, to communications systems utilized with gaming devices and gaming device networks that enable and act as an interface between wagering peripherals and/or other downstream devices and processing centers (Hubs). More particularly, this invention relates to methods and apparatus for providing the secure and reliable transmission of wagering information between a plurality of wagering peripherals and/or terminals and at least one central processing center or central wagering hub.

The current state of the art in the industry for this type of product is the Terminal Network Interface One (“TNI-1”) which is a highly versatile, cost effective communications device that is used exclusively to interface serial wagering peripherals (up to 150 terminals) to a localized processing center or hub. The TNI-1 utilizes a high encryption algorithm and can safely use the Internet as an inexpensive communications alternative, while at the same time guaranteeing the secure, non-repudiated transmission of wagering transactions. The reliability of the TNI-1 is achieved through its built-in modem/ISDN dial-up backup along with the secure operating system. At present the technology and methods utilized by the TNI-1 for the safe and secure transmission of wagering information between the wagering peripherals and the central processing centers are limited in the types of peripheral and/or downstream devices that they are capable of connecting to in both type and quantity. For instance, the current technology that is employed by the TNI-1 only has the capability of providing serial type connections to a very limited quantity of serial type peripheral devices.

The TNI-1 is capable of communicating using a variety of protocols including but not limited to, TCP/IP over Ethernet and asynchronous Point-to-Point Protocol. For TCP/IP Connectivity via Ethernet, the TNI-1 supports the use of static IP, DHCP, and PPPOE addressing. The Ethernet port operates over both 10 and 100 Mbps connection rates. For TCP/IP Connectivity via PPP the PPP interface of the TNI-1 can be used to either dial a private modem pool or a public internet ISP. A limitation of this PPP interface on the TNI-1 is that it requires the use of Plain Authentication Password (“PAP”). The TNI-1 does not support the Challenge Handshake Authentication Protocol (“CHAP”). The PPP configuration for the TNI-1 also requires the phone number of the modem pool, the username and password, and the baud rate of connection from the TNI-1 to the modem.

### REFERENCES TO RELATED DOCUMENTS

U.S. Pat. No. 5,847,751 to Safadi discloses a network architecture for delivery of broadcast and interactive digital services over a hybrid fiber-coax distribution system. The network includes at least one remote/local hub that communicates with a plurality of video information providers (VIPs) and a plurality of headends/central offices. Each headend communicates with a plurality of settop terminals. The hub includes a backbone subnetwork which provides the physical medium for components within the hub to communicate with each other, and for entities located outside the hub, such as the VIPs and the headends, to communicate with, and through, the hub. The hub processes broadcast digital information services from a VIP and distributes the services directly to the plurality of settop terminals. The network architecture permits two-way transparent data transport service between the VIPs and the video information users. Through frequency division multiplexing, the network architecture facilitates analog signal distribution so both analog and digital services can be distributed.

U.S. Pat. No. 5,684,799 discloses a video distribution network having an architecture that distributes video services over a greater serving area. The broadcast consolidation section receives broadband data from a plurality of information providers, preferably as compressed, digital signals using asynchronous transfer mode ATM transport. The broadcast consolidation section combines the ATM streams from different information providers and outputs a single consolidated signal onto a transport ring. The broadcasting ring supplies the consolidated broadcast signal to a plurality of video network hubs, each of which downloads the consolidated broadcast data, converts the consolidated broadcast data to motion picture experts group MPEG data on an RF carrier, and combines the RF signal with other RF signals before transmission by optical fiber to a plurality of local video access nodes. Each local video access node combines the RF broadcast data from the corresponding video network hub with downstream interactive multimedia television IMTV traffic supplied by an ATM backbone subnetwork. The combined RF signals are output from the local video access nodes to the access subnetwork servicing these subscribers. The architecture of this invention provides sufficient allocation of resources, while at the same time providing efficient transport of signaling traffic and interactive data. In addition, the network control is centralized for more efficient management of resources.

U.S. Pat. No. 5,822,603 discloses a programmable media processor for processing and transmitting a media data stream of audio, video, radio, graphics, encryption, authentication and networking information in real time. In particular, a broadband minicomputer has a general purpose media processor that transmits media data streams received from upstream network components to downstream devices. Additionally, the invention allows network owners the ability to track standards and deploy new services by broadcasting software across the network.

U.S. Pat. No. 5,572,517 discloses a communication network with a hub which communicates with headends/central office, each of which in turn communicates with various settop terminals. Furthermore, the communication network interfaces with a plurality of video information providers. Each settop terminal includes a network module for interfacing with the CATV transmission network. The settop terminals are the interface between the television of a video information user and the network. Additionally, to provide bidirectional communication flow over the network, the frequency spectrum of the physical medium from the headend to the settop terminals is divided into a downstream signal path and upstream signal network controllers to the headend as needed. Also, the network module communicates with the addressable controller for access control and decryption/encryption authorization.

U.S. Pat. No. 5,684,799 discloses an improved distributed network architecture that distributes video services over a greater area, while at the same time allowing for point-to-point video services. Even more, the network is adapted to transport any type of data that satisfies the interface requirements of the network, enabling the transport of interactive multimedia services like the Internet. Encryption is also enabled. Furthermore, upstream signaling traffic from a video information user to the level 1 gateway or the video data control center is done through dedicated virtual paths. In addition, downstream interactive multimedia television is supplied by an ATM backbone network.

U.S. Pat. No. 6,240,553 discloses an interactive information distribution system connected to a communications network. Furthermore, upstream messages are received from subscribers through a reverse data channel, and downstream messages are transmitted to subscribers through a forward data channel, both of which are supported by the communications network. Even more, a session controller sends encryption keys to settop terminals via the forward data channel. Also, the transmission of video data streams is provided, as is different services such as interactive shopping and internet access.

U.S. Pat. No. 6,996,129 discloses an advanced multiplexer designed and optimized for next-generation on-demand video distribution. In particular, the system comprises a session manager, a video server, a multiplexer, at least one modulator and an encrypter. The session manager interacts with a variety of client devices. Furthermore, a direct communication path exists between the session manager and each client, utilizing network links and modulated upstream or downstream channels and has a network interface such as an Ethernet cable.

U.S. Patent Number 20040264964 discloses a fiber-to-the-curb (FTTC) communication system for delivering residential and/or business telecommunications services over a hybrid fiber-coaxial (HFC) distribution network. Furthermore, television programming and video on-demand services are provided from the cable head-end. Even more, most signals are sent downstream to a subscriber, but some are received upstream such as a request from a subscriber to watch a pay-per-view program. Internet access may be provided requiring a cable modem at the head-end.

U.S. Patent Number 20060217199 discloses an on-line gaming or other activity system utilizing videoconferencing or other communication methods in a broadband network provides remote locations with live video/audio of the on-going game or activity occurring at a different location. The casino network device (such as a router, switch, hub or other modem device) coupled to the network would provide internal addressing for each slot machine terminal and transparent remote user. A remote player terminal generates and transmits video/audio of the remote player to the bridge/gatekeeper. The dealer terminal receives video/audio signals from the bridge/gatekeeper. The VCU includes circuitry and functionality to provide video and audio processing, network interfacing, videoconferencing, and IP communications processing in accordance with various protocols.

U.S. Patent Number 20070155507 discloses a method for in-room gaming suitable for cruise ships and remote hotels that allows players to play electronic games of skill or chance on their room TV or on any other available TV.

U.S. Patent Number 20050107157 discloses a secure offline interactive gambling system. The system includes a set-top box which may uses a telephone link of a telephone network for transmitting the upstream transmissions related to the offline interactive gambling application to the headend. Alternatively, the telephone link may also be used for transmitting the downstream transmissions from the headend to the set-top box.

Patent Number WO2007021507 discloses an optical system with a video overlay. Furthermore, the system includes a headend that transmits downstream network signals through an optical network with at least multicast video. An optical network termination is coupled to the headend through the optical network and is arranged to receive downstream signals from the headend, snoop the multicast video signals, and route the multicast signals to receiving destinations.

### BRIEF SUMMARY OF THE INVENTION

The present invention, the Terminal Network Interface 2 (“TNI-2”) is a communications concentrator or a communications multiplexer that is specifically designed for use in association with wagering and pari-mutuel wagering applications and the secure and reliable transmission of information between a plurality of wagering peripherals and a central wagering hub. The TNI-2 is a highly versatile, cost effective communications device which is used to interface a plurality of wagering peripherals to at least one central processing center (hub). Utilizing the latest high encryption algorithm, the TNI-2 is capable of safely utilizing the Internet as an inexpensive communications alternative, while guaranteeing secure, non-repudiated wagering transactions. The reliability in the TNI-2 is achieved through its built-in intelligent modem/ISDN dial-backup along with a secure operating system.

The TNI-2 was invented to solve a variety of problems that the original TNI-1 was unable to resolve. The original TNI-1 was designed for use in very small locations with very few peripheral terminals (typically less than 30 terminals). Additionally, the only type of terminals that the TNI-1 was capable of supporting are legacy serial terminals. New terminals have been and are currently being developed that rely on the TCP/IP protocol instead of serial. However, the only way for these new TCP/IP devices to communicate with the Central Wagering Hub was through a very expensive server based communications concentrator. Furthermore, this server based communications concentrator required the use of additional expensive networking equipment in order to interface to the communications network. The TNI-2 solves this problem by providing a cost effective method for the new TCP/IP terminals to interface with the central wager processing center.

The TNI-2 also provides the additional capability of addressing the needs of locations that either require or desire racing related television displays to be generated. Prior to the development of the TNI-2, in order to fulfill this need, a separate server was required to convert a data stream from a Central Wagering Hub into a video output for use by peripheral devices. The TNI-2 has solved this problem by integrating this process and thus eliminating the additional expense and complexity involved with an external video generator. The TNI-2 provides the additional advantage of being capable of supporting thousands of TCP/IP devices and serial devices whereas the original TNI could only support 5 downstream serial lines.

An exemplary method for using the TNI-2 to facilitate the processing and acknowledgement of wagering information between a plurality of peripheral devices and a central wagering hub involves an end user inputting a message into a peripheral device. The peripheral device then transmits this message to the TNI-2 where the TNI-2 inserts an appropriate data field into the message which will later allow the Central Wagering Hub to identify the specific source peripheral device from where the message originated. The TNI-2 then proceeds to transmit this message, now with the additional data field inserted, to the Central Wagering Hub via a TCP/IP network. Upon receipt of this message, the Central Wagering Hub processes this message and generates an acknowledgment message to be transmitted back to the TNI-2 via a TCP/IP network. The Central Wagering Hub then transmits the acknowledgment message back to the TNI-2. The TNI-2 then processes the acknowledgment message from the Central Wagering Hub in order to determine from which specific peripheral device the transmission originated. Upon determination of the appropriate downstream device, the TNI-2 then transmits the acknowledgment message back to the peripheral device from which the message originated. The originating peripheral device then processes the returned data.

A second exemplary method for using the TNI-2 to facilitate the processing and acknowledgement of information between a plurality of peripheral devices and a central wagering hub involves a peripheral device generating a message independently without any end user input. The peripheral device then transmits the message to the TNI-2 where the TNI-2 inserts an appropriate data field into the message which will later allow the Central Wagering Hub to identify the specific source device from where the message originated from. The TNI-2 then proceeds to transmit the message, with the additional data field, to the Central Wagering Hub via a TCP/IP network. Upon receipt of the message, the Central Wagering Hub processes the message and generates an acknowledgment message to be transmitted back to the TNI-2 via a TCP/IP network. The Central Wagering Hub then transmits the acknowledgment message back to the TNI-2. The TNI-2 then processes the acknowledgment message from the Central Wagering Hub in order to determine from which specific peripheral device the transmission originated. Upon determination of the appropriate downstream device, he TNI-2 then transmits the acknowledgment message back to the peripheral device from which the message originated. The originating peripheral device then processes the returned data.

A third method for using the TNI-2 to facilitate the processing and acknowledgement of wagering information between a plurality of peripheral devices and a central wagering hub involves a message originating at the Central Wagering Hub either independently or as a result of some user input. The Central Wagering Hub then transmits the message to the TNI-2 where the TNI-2. The TNI-2 then determines which specific downstream peripheral device the message is intended for and proceeds to transmit the message to said specific device. Upon receipt of the message, the peripheral device processes the message. If necessary, the peripheral device will generate an acknowledgement message to be sent back to the Central Wagering Hub through the TNI-2 via the same pathway.

In one embodiment, this disclosure provides a terminal network interface that includes the ability to connect and transmit information between a Central Wagering Hub and a plurality of Ethernet enabled peripheral devices.

In another embodiment, this disclosure provides a terminal network interface that includes the ability to connect and transmit information between a Central Wagering Hub and a plurality of downstream peripheral devices utilizing wireless Ethernet technology.

In another embodiment, this disclosure provides a terminal network interface that includes an internal character generator which provides the ability to generate a formatted video output and then transmit said formatted video output to a plurality of downstream video output devices such as televisions or monitors.

In another embodiment, this disclosure provides a terminal network interface that includes the ability to connect and transmit information between a Central Wagering Hub and a plurality of Serial enabled peripheral devices.

Other potential embodiments may include a terminal network interface that includes the ability to connect and transmit information between a Central Wagering Hub and a plurality of downstream devices through any combination of the above noted connections.

In yet another potential embodiment the terminal network interface may incorporate a hard drive or other type of built-in storage or memory device for the storage of information, which information may then be transmitted between the Central Wagering Hub and a plurality of peripheral downstream devices.

The present invention has several important advantages. Various different embodiments of the invention may incorporate none, some, or all of these advantages. One advantage of the present invention is that it provides the ability to connect to and communicate with a variety of downstream peripheral devices, requiring a variety of connection types, through a single terminal network interface. For example, the TNI-2 is capable of total connectivity, meaning that through a single TNI-2 the Central Wagering Hub can communicate with serial, Ethernet and wireless peripheral devices. Another advantage of the TNI-2 is that it is placed, on site, at the location where the peripheral devices are located and remote from the location where the Central Wagering Hub is located. The types of downstream devices that the TNI-2 is capable of providing connectivity to include but are in no manner limited to legacy serial devices such as Ticket Issuing Machines (TIMS), Display Processors, Infield Display Controllers, Inter-Track Wagering (“ITW”) lines, DecWriters, Printers, administrative devices, etc.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 illustrates a block diagram of an exemplary configuration of the Terminal Network Interface (“TNI-2”) and how it connects with a Central Wagering Hub.

FIG. 2 illustrates a flow chart of an exemplary configuration of an overall network incorporating a Terminal Network Interface (“TNI-2”) to interface between a Central Wagering hub and a plurality of peripheral devices and provide for the secure and reliable transmission of information between a plurality of wagering peripherals and other downstream devices.

FIG. 3 illustrates a flow chart of an exemplary pathway through which information is transmitted between the TNI-2 Message Processing Engine and the upstream system or TCP/IP Network.

FIG. 4 illustrates a flow chart of an exemplary method of internal message switching which takes place in the TNI-2 Message Processing Engine.

FIG. 5 illustrates a flow chart of an exemplary pathway through which information is transmitted between the TNI-2 and Serial devices.

FIG. 6 illustrates a flow chart of an exemplary pathway through which information is transmitted between the TNI-2 and Ethernet devices.

FIG. 7 illustrates a flow chart of an exemplary pathway through which information is transmitted from the TNI-2 to Video display devices.

### DETAILED DESCRIPTION OF THE INVENTION

The invention comprises a method and apparatus for enabling the communication between a plurality of peripheral downstream devices, including but not limited to, wagering devices, administrative devices, video displays, and one or more central processing centers or hubs. The following description sets forth numerous specific details with reference to a few preferred embodiments thereof as illustrated in the accompanying drawings, to provide for a more thorough description and understanding of the present invention. It will be apparent, however, to one skilled in the art that the present method and apparatus may be practiced without these specific details. In other instances, well-known process steps, features and/or structures have not been described in detail in order to avoid unnecessarily obscuring the present invention. The various aspects and features of the invention may be utilized alone or in any combination.

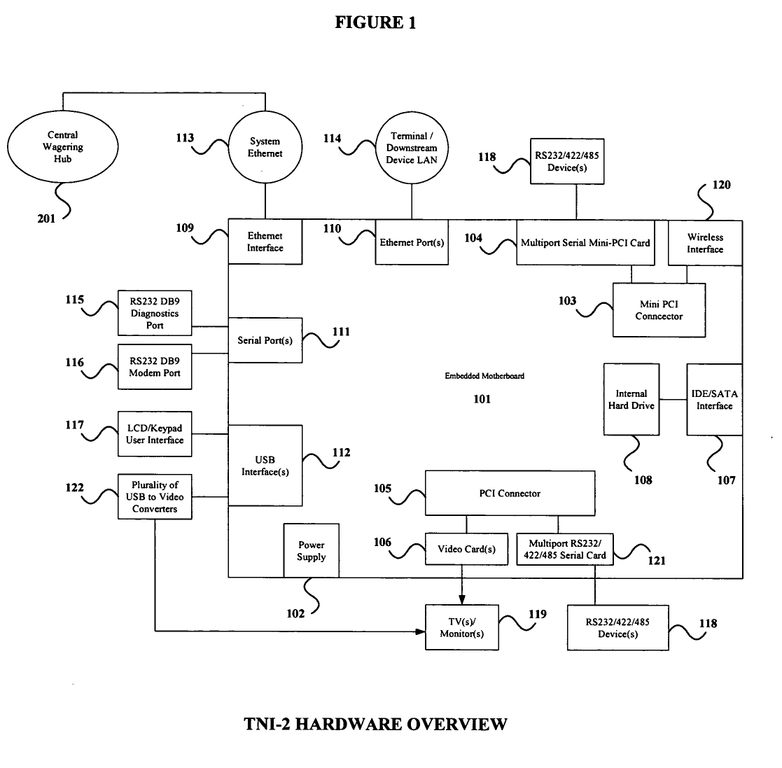

FIG.1 illustrates a block diagram of an exemplary configuration of the Terminal Network Interface (“TNI-2”) wherein the TNI-2 205 is comprised of the main CPU 101, Memory/RAM and flash non-volatile storage along with many interfaces such as a plurality of integrated Ethernet ports 109-110, Mini-PCI Connector(s) 103, PCI connector(s) 105, a plurality of Serial ports 111, a plurality of USB ports 112, and an Internal Hard Drive Interface 107. The Mini-PCI Connector 103 may be utilized to interface with devices such as an on board Serial Port Expansion Card 104 or a Wireless Adapter Card 120.

The onboard PCI Connector(s) 105 can be utilized to interface to Video Cards 106 which can then output video to a plurality of video display devices 119, such as TVs or monitors.

The TNI-2 205 has a plurality of Ethernet ports 109-110 which may be used to connect to the System LAN 113, to a Terminal/Downstream device LAN 114, as well as to a variety of other LAN's that may need to communicate with the Central Wagering Hub 201 in order to process and/or communicate wagering services.

The plurality of built-in serial ports 111 may be used for a variety of interfaces, such as a diagnostics interface 115 to the TNI-2 205 or to connect a modem 116 to the TNI-2 205 for dial-backup purposes.

The USB ports are used to interface to a LCD/Keypad device 117 and optionally a plurality of USB to video converters 122.

The IDE/SATA Interface 107 is used to communicate with an Internal Storage Device 108. The Internal Storage Device can include an internal hard drive, a compact flash card, etc.

The System Ethernet 113 is used to connect to a TCP/IP LAN to communicate with the Central Wagering Hub 201.

The Terminal/Downstream Device LAN 114 is used to communicate with TCP/IP wagering terminals and other TCP/IP devices.

The Multiport Serial Mini-PCI Card 104 is used to provide additional serial ports to the TNI-2 205 for legacy serial devices to communicate.

Serial Devices 118 can be serial terminals, administrative devices, or any other serial devices. The RS232 Serial Diagnostic Port 115 is used by developers to debug the TNI-2 205. The RS232 DB9 Modem Port 116 is used to connect to an external serial modem or a terminal adapter for dial-backup purposes.

The LCD/Keypad User Interface 117 is the method by which the user of the TNI-2 205 monitors and configures the TNI-2 205.

The Video Card(s) 106 may be used to generate the graphics from a frame buffer to display on multiple televisions or monitors 119. The multiple televisions or monitors 119 attach to the TNI-2 205 via a standard video cable and display video output.

The USB to video converters 122 allow for a less expensive solution for supporting video graphics displays, and provide the ability to increase in the number of monitors that can be connected through the TNI-2. The video cards 106 can only support 2 monitors while the USB to video converters are capable of supporting 16 monitors.

The Internal Hard Drive 108 may be used for the storage of large amounts of files for use by downstream devices.

The Power Supply 102 may be capable of working on either 110 or 120 volts. The TNI-2 205 converts the power into 5 volt power for the TNI-2 205 to use.

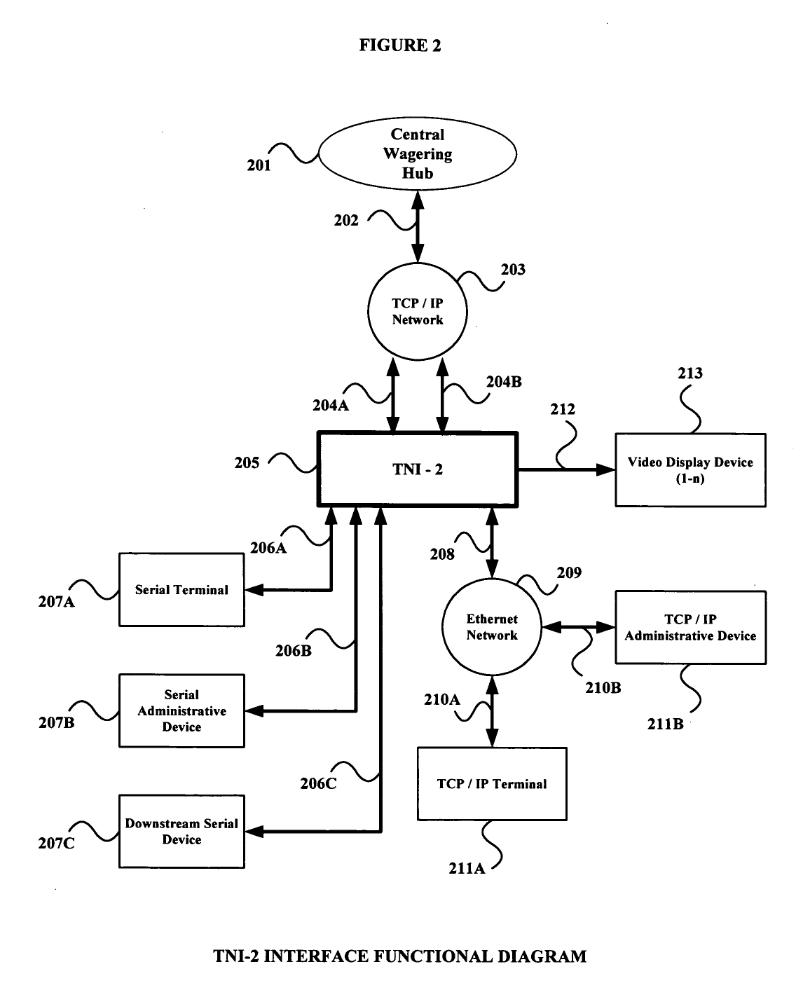

FIG. 2 illustrates a block diagram of an exemplary configuration of an overall network incorporating a Terminal Network Interface (“TNI-2”) 205 to interface between a Central Wagering Hub 201 and a plurality of peripheral devices 207A-207C, 211A-211B, and 213 and provides for the secure transmission of information. As shown a Central Wagering Hub 201 generally contains a number of computers which make up the Central wager processing system. Transmissions from external devices, including but not limited to Serial Devices 207A-207C, and TCP/IP Devices 211A-211B enter into the Central Wagering Hub 201 where a computer system processes the wager, and then returns an acknowledgment of a transmission request back to the originating device. The Central Wagering Hub 201 interfaces to a TCP/IP network 203 for communications to and from external devices.

The TCP/IP network 203 can be any IP compatible network. Examples of this include, but are not limited to, Ethernet (10, 100, 1000 Mbps), serial/modem connections via the point-to-point protocol (PPP), 56k DDS, T1, Frame-relay, MPLS, Internet VPN's or any combination of the above. The TNI-2 205 is an intelligent concentrator or multiplexer. The TNI-2 205 processes messages from a Central Wagering Hub 201 and determines which downstream device to send the message to. When a downstream device sends a message to the Central Wagering Hub 201, the TNI-2 205 inserts a proper data field into the message so that the Central Wagering Hub 201 knows the source device the message originated from. The upstream connection to the system is a TCP socket to a server within the Central Wagering Hub 201. The connection can be initiated over an integrated Ethernet connection 204A in the TNI-2 205 or via a PPP connection 204B by an attached modem or terminal adapter. The downstream devices on the TNI-2 205 may include, among other devices, serial devices 207A-207C via a RS232/422/485 interfaces 206A-206C, TCP/IP devices 211A-211B (wired and/or wireless) via an Ethernet interface 208 and attached video display devices 213 via any standard video connector.

A Serial Terminal 207A is an end-user device for which a teller at a remote site may place a wager or an unattended device where a patron may place a wager without interacting with a teller. Serial terminals 207A are polled protocols over a RS422/485 4 wire connection 206A. Up to 30 polled protocols may exist on one serial port on the TNI-2 205.

A Serial Administrative Device 207B is a computer located on-site at a remote location and is used to monitor, control and report on the operations of the wagering devices at the location. Examples of such control include allowing the terminals to accept wagers, creating reports for the mutual department and other such interactions required to operate a wagering location. The administrative device is connected to a TNI-2 205 over a serial connection 206B.

There are often requirements of a plurality of miscellaneous serial devices 207C at a wagering location. These miscellaneous serial devices 207C may include printers; an external odds feed for third party entities to process, and various other types of serial devices. These miscellaneous serial devices 207C are connected to a TNI-2 205 over a serial connection 206C.

For a plurality of downstream TCP/IP terminals 211A to interface to the TNI-2 205, an Ethernet Network 209 interconnects the TCP/IP Terminals 211A and the TCP/IP Administrative Devices 211B to the TNI-2 205. These TCP/IP Devices 211A-211B are connected to the Ethernet Network over Ethernet connections 210A-210B where connections 210A-210B can be either wired or wireless Ethernet connections.

A TCP/IP Terminal 211A is typically an end-user device for which a teller at a remote site may place a wager or an unattended device where the patron may place the wager without interacting with a teller. Peripheral TCP/IP terminals 211A communicate with the TNI-2 205 over a TCP socket, wherein the TCP/IP terminal 211A is the TCP client and the TNI-2 205 is the TCP server.

A TCP/IP Administrative Device 211B is a computer at a remote location which is used to monitor, control and report on the operations of the wagering devices at the location. Examples of such control include, but are not limited to, allowing the terminals to accept wagers, creating reports for the mutual department and other such interactions that are required to operate a wagering location. The TCP/IP Administrative Device 211B is connected to a TNI-2 205 over a TCP socket, where the TCP/IP Administrative Device 211B is a TCP client and the TNI-2 205 is a TCP server.

One of the optional interfaces available on the TNI-2 205 is the ability for the TNI-2 205 to generate a dynamic video image such as an odds display which is then outputted to a Video Display Device 213. The Video Display Device 213 can be a television, a monitor or any other device capable of displaying video. The TNI-2 205 has an integrated internal character generator 703 that is able to process a data stream from the Central Wagering Hub 201 and generate a dynamic video image to be displayed on the Video Display Device 213. Numerous video display devices 213 can exist on the TNI-2 205, each displaying an independent dynamic video image.

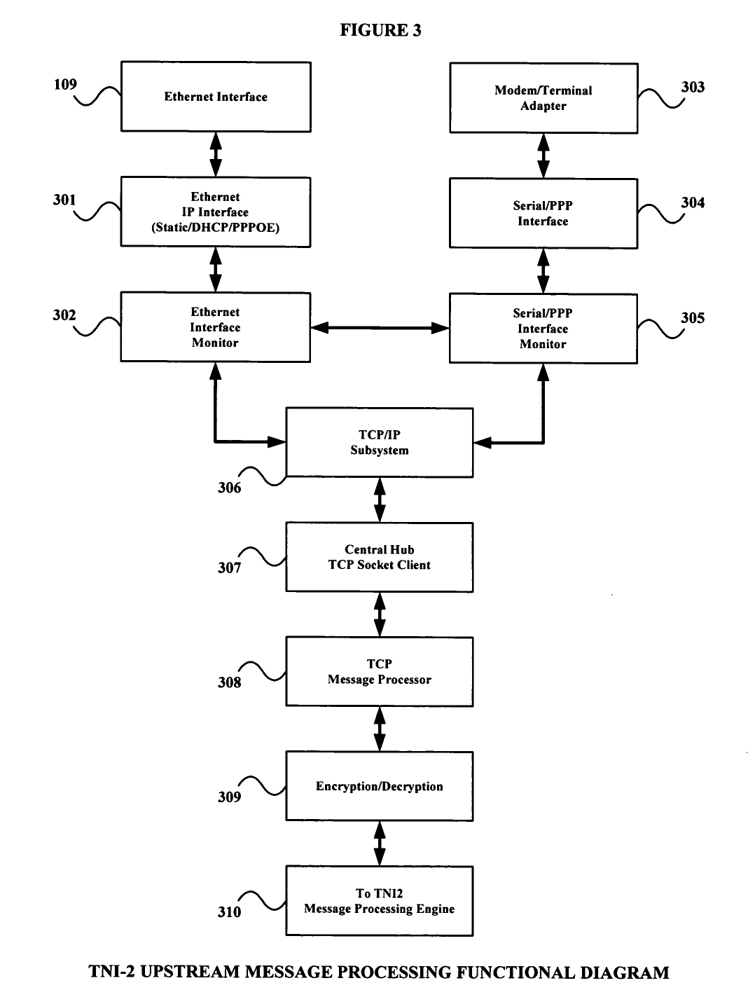

FIG. 3 illustrates a flow chart of an exemplary pathway through which information is transmitted between the Central Wagering Hub 201 and the TNI-2 205. The information begins at the Ethernet Interface 109 which connects to TCP/IP Network 203 via 204A with TCP/IP connectivity to the Central Wagering Hub 201.

The Ethernet IP Interface 301 handles the IP addressing of the Ethernet Interface 109. Depending on the mode of the configuration, this process handles the assignment of IP addressing information for Static IP, Dynamic Host Configuration Protocol (DHCP) or the Point-to-Point Over Ethernet (PPPOE) IP addressing methods.

The Ethernet Interface Monitor 302 controls the Ethernet Interface 109 by regularly monitoring the Ethernet Interface 109 to determine its state. If the state of the Ethernet Interface 109 is not suitable for use (i.e., no IP address or no connection to an Ethernet Network) then the Ethernet Interface Monitor 302 signals the Serial/PPP Interface Monitor 305, if present, to attempt to establish a connection via the Modem/Terminal Adapter 303.

A Modem or ISDN Terminal Adapter 303 can also be attached to the TNI-2 205 to provide a dial-up connection to a remote Central Wagering Hub 201. The modem 303 communicates to the TNI-2 205 over a serial connection. The Serial/PPP Interface 304 handles the lower level communications layer of running TCP/IP over a serial connection.

The Serial/PPP Interface Monitor 305 monitors the status of the Serial/PPP Interface 304 to a remote network. If a link is broken (i.e. the modem disconnects), this module will attempt to reconnect the modem 303 to the remote network. If the Ethernet Interface Monitor 302 determines the Ethernet IP Interface 301 is not suitable for network connections, then the Serial/PPP Interface Monitor 305 can initiate a dial-up connection automatically in order to try to establish a connection. This method of automatic dial-up backup is used to keep the modem 303 connected as little as possible in order to reduce costs.

The TCP/IP Subsystem 306 handles the OSI layers 3 through 4 of the TCP/IP communications protocol.

The Central Hub TCP Socket Client 307 establishes a TCP socket connection to the TCP server which is located in the Central Wagering Hub 201. If a TCP session becomes disconnected, then the Central Hub TCP Socket Client 307 automatically attempts to reconnect.

The TCP Message Processor 308 converts the data stream that TCP provides into datagram oriented messages. This is accomplished by using the SOH/EOT/ETX/DLE datastream break characters to interpret incoming stream data into independent data blocks.

The Encryption and Decryption engine 309 decrypts incoming packets and encrypts outgoing packets. The TNI-2 205 can be configured to use any encryption protocol such as the Advanced Encryption Standard (AES), Secure Socket Layer (SSL) or the Transport Layer Security (TLS) encryption protocols.

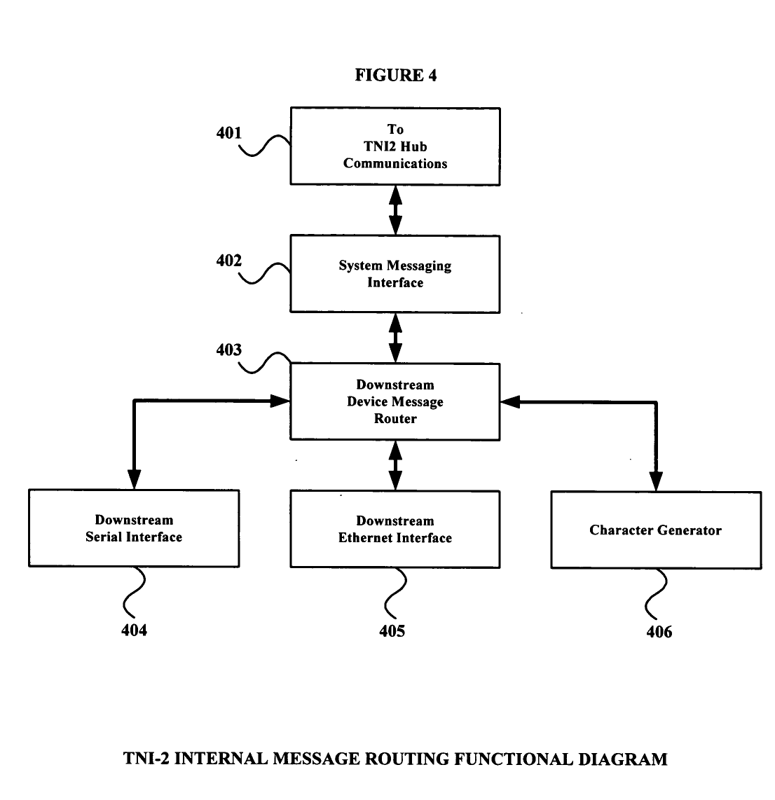

FIG. 4 illustrates a flow chart of an exemplary pathway through which information is processed and transmitted within the TNI-2 in which the System Messaging Interface 402 processes messages from the Central Wagering Hub 201 to the downstream lines and vice versa. For incoming messages, the System Messaging Interface 402 first determines if the message is a configuration message intended for the TNI-2 205 or a message which is intended for a downstream device 207A-207C, 211A-211B, and 213. If the message is a configuration message, the System Messaging Interface 402 sends the message to the Downstream Message Switching Controller 403 in order to change the downstream message switching controller's routing table. If the message is intended for a downstream device, the System Messaging Interface 402 sends the message to the Downstream Device Message Controller 403 so that it may then be forwarded to the correct downstream device. The System Messaging Interface 402 also monitors of the status of the connection to the Central Wagering Hub 201. If the Central Wagering Hub 201 stops sending keep-alive messages to the TNI-2 205, the System Messaging Interface 402 will recognize and notice this failure and will then disconnect the current Central Wagering Hub 201 connection and attempt to reestablish the connection.

The Downstream Device Message Router 403 contains a routing table that knows the location of each type of downstream device, whether it is a Serial device 207A-207C, an Ethernet device 211A-211B, an Internal Character Generator 406 or some other type of device. This module assures the messages are routed to the proper device.

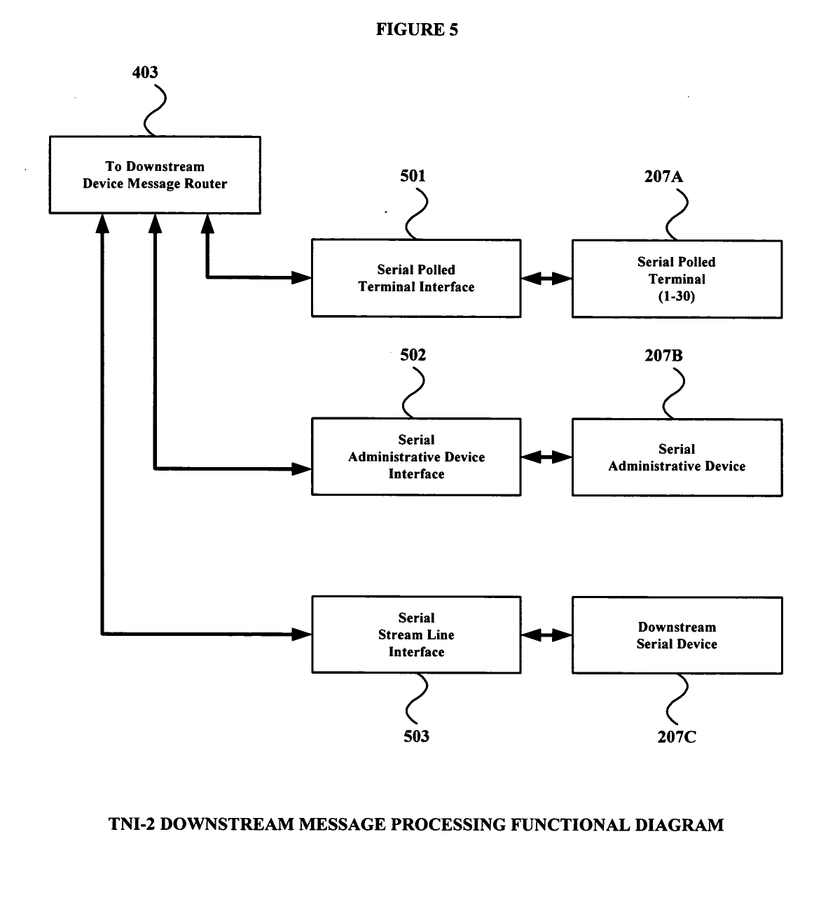

The Downstream Serial Interface 404 is an interface to the downstream serial devices 207A-207C, as described in FIG. 5.

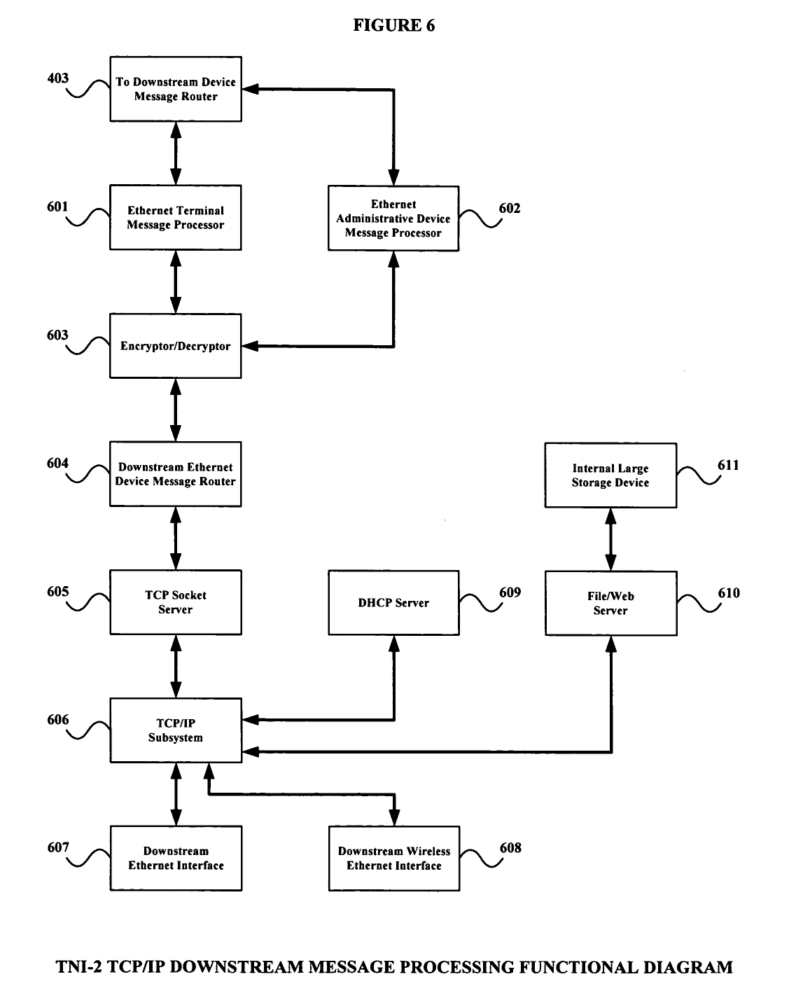

The Downstream Ethernet Interface 405 is an interface to the downstream Ethernet devices 211A-211B, as described in FIG. 6.

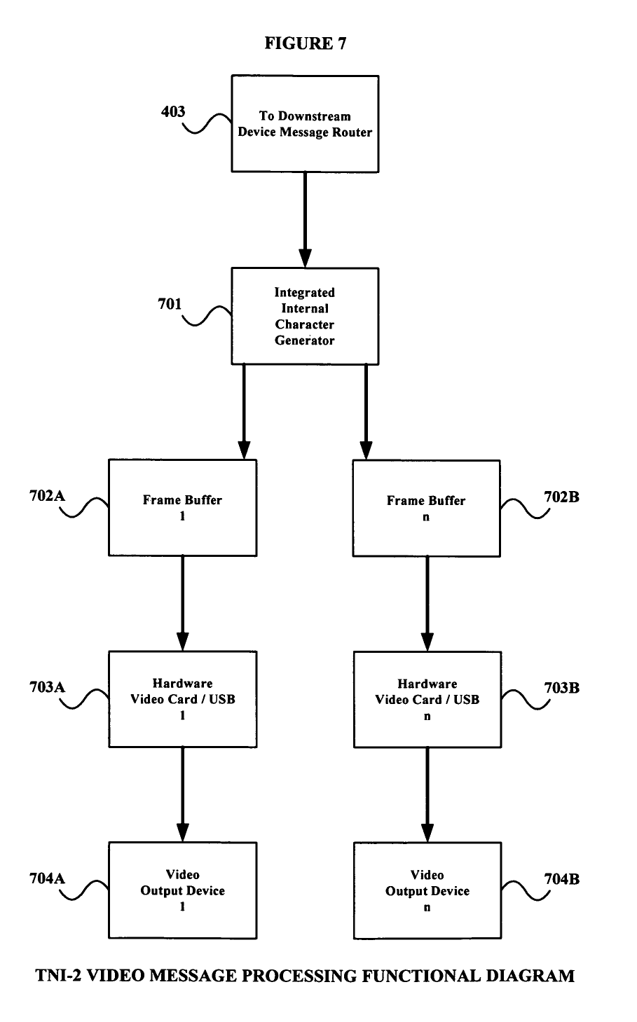

The Internal Character Generator 406 is an interface to the optional internal character generator, as described in FIG. 7.

FIG. 5 illustrates a flow chart of an exemplary pathway through which information is transmitted between the TNI-2 and Serial devices wherein the Serial Polled Terminal Interface 501 processes messages to and from Serial Polled Terminals 207A attached to the TNI-2 205. Polled Serial Terminals 207A interface to the TNI-2 205 via a RS422/485 differential serial port. The Serial Polled Terminal Interface 501 queries Polled Serial Terminals 207A, one at a time, in order to determine if any data needs to be transmitted to the system. Once the Serial Polled Terminal Interface 501 receives this information, the Serial Polled Terminal Interface 501 sends the information to the Device Message Router 403 to be forwarded to the Central Wagering Hub 201.

A Serial Polled Terminal 207A is a device from which wagers are placed. The Serial Polled Terminal 207A interfaces to the TNI-2 205 over a serial connection.

The Serial Administrative Device Interface 502 formats messages from the Downstream Device Message Router 403 in order to communicate to a Serial Administrative Device 207B. This communications protocol includes adding data windowing capability as well as checksums in order to make the communications to the Serial Administrative Device 207B quicker and more reliable.

The Serial Administrative Device 207B is a computer which runs a program to interface to the TNI-2 205 over a communications link. The Serial Administrative Device 207B is used to control racing as well as to process reports.

The Serial Stream Line Interface 503 is a raw serial stream message switcher. Any message from the system Central Wagering System is directly transmitted on a local serial interface on the TNI-2 205. Likewise, any data received on the serial port is directly forwarded to the Downstream Device Message Router 403, and ultimately to the Central Wagering Hub 201.

The Downstream Serial Device 207C can be any serial device that communicates in a raw manor to the Central Wagering Hub 201 system. An example of this could be a serial printer.

FIG. 6 illustrates a flow chart of an exemplary pathway through which information is transmitted between the TNI-2 and Ethernet devices wherein the Ethernet Terminal Message Processor 601 formats the data messages from the Downstream Device Message Controller 403 into a format intended for the Ethernet Terminal 211A to understand.

The Ethernet Administrative Device Message Processor 602 formats the data messages received from the Downstream Device Message Controller 403 into a format intended for the Downstream Ethernet Administrative Device 211B to understand.

The Encryptor/Decryptor 603 optionally decrypts data coming from the Downstream Ethernet Devices 211A-211B and encrypts data going to the Downstream Ethernet Devices 211A-211B.

The Downstream Ethernet Device Message Router 604 keeps track of all of the incoming TCP/IP connections and associates each connection with the appropriate Ethernet Terminal 211A or Ethernet Administrative Device 211B.

The TCP Socket Server 605 makes the TNI-2 205 a TCP server. The TNI-2 205 listens for incoming connections from remote Ethernet devices 211A-211B.

The TCP/IP Subsystem 606 is the TCP/IP interface between the TNI-2 205 software and the operating system.

The Downstream Ethernet Interface 607 is the physical interface to the Ethernet Network 209. All downstream Ethernet devices 211A-211B initiate connections through this Downstream Ethernet Interface 607.

The Dynamic Host Configuration Protocol (DHCP) Server 609 is responsible for assigning dynamic TCP/IP addresses for the Downstream Ethernet Devices 211A-211B connected to the Downstream Ethernet Interface 607.

Optionally, the TNI-2 205 can contain an Internal Large Storage Device 611 for files that are required by downstream Ethernet devices 211A-211B. The File/Web Server 610 is responsible for sending these files to the appropriate downstream device requesting the file.

The Internal Large Storage Device 611 is usually a hard drive used to store files, but could be any data storage device.

The TNI-2 205 can optionally contain an Internal Wireless Ethernet Interface 608 for communicating with the downstream Ethernet devices 211A-211B.

FIG. 7 illustrates a flow chart of an exemplary pathway through which information is transmitted from the TNI-2 to Video display devices wherein any data received from the Downstream Device Message Router 403 are processed by the Internal Character Generator 701. The Internal Character Generator 701 takes a datastream of commands and uses those commands to format a formatted video output in the form of a frame buffer.

The frame buffer then stores the video output that was created in the Internal Character Generator 701. Multiple Frame buffers exist because there can be multiple independent video output devices 704A-704B, each independent video output device 704A-704B displaying a unique display created from the Internal Character Generator 701.

The Hardware Video Card/USB 703A-703B is the physical interface between the Frame Buffer 702A-702B and the video output of the TNI-2 205.

The Video Output Device 704A-704B is how the image generated in the TNI-2 205 is displayed. The Video Output Device 704A-704B could be a monitor, television, or any other device capable of displaying a video output.

I claim:

1. An embedded terminal network interface, comprising:
a plurality of Ethernet ports;
a plurality of Serial ports;
a plurality of USB ports;
an embedded mother board;
a LCD/keypad user interface;
a power supply;
wherein said embedded terminal network interface is housed in a metal enclosure that may be rack mountable, wall mountable, or free standing and is placed at a location local to where the wagers are placed.

2. The Terminal Network Interface of claim 1 further comprising;
a Mini PCI Connector;
a Multiport Serial Mini PCI card;
wherein said Mini PCI Connector and said multiport serial mini PCI card are used to interface with on board serial port expansion cards for communicating with legacy serial devices.

3. The Terminal Network Interface of claim 1 further comprising;
a Mini PCI Connector;
a wireless adapter card;
wherein said Mini PCI Connector is used to interface to said wireless adapter card.

4. The Terminal Network Interface of claim 1 further comprising;
at least one PCI Connector;
a plurality of video cards;
wherein said PCI Connector is used to interface with a plurality of video cards and said plurality of video cards are used to generate graphics for display on one or more video display devices.

5. The Terminal Network Interface of claim 1 further comprising;
at least one PCI Connector;
at least one multiport serial card;
wherein said PCI Connector and said multiport serial card are used to interface with on board serial port expansion cards for communicating with legacy serial devices.

6. The Terminal Network Interface of claim 1 further comprising;
a plurality of USB to video converters;
wherein said USB to video converters are used to generate graphics for display on one or more video display devices.

7. The Terminal Network Interface of claim 1 further comprising;
an IDE/SATA Interface;
an internal storage device;
wherein said IDE/SATA Interface is used to communicate with an internal storage device and said internal storage device is for use to store a large amount of files for use by downstream peripheral devices.

8. The Terminal Network Interface of claim 2 further comprising;
an IDE/SATA Interface;
an internal storage device;
wherein said IDE/SATA Interface is used to communicate with an internal storage device and said internal storage device for use to store a large amount of files for use by downstream peripheral devices.

9. The Terminal Network Interface of claim 3 further comprising;
an IDE/SATA Interface;
an internal storage device;
wherein said IDE/SATA Interface is used to communicate with an internal storage device and said internal storage device for use to store a large amount of files for use by downstream peripheral devices.

10. The Terminal Network Interface of claim 4 further comprising;
an IDE/SATA Interface;
an internal storage device;
wherein said IDE/SATA Interface is used to communicate with an internal storage device and said internal storage device for use to store a large amount of files for use by downstream peripheral devices.

11. The Terminal Network Interface of claim 5 further comprising;
an IDE/SATA Interface;
an internal storage device;
wherein said IDE/SATA Interface is used to communicate with an internal storage device and said internal storage device for use to store a large amount of files for use by downstream peripheral devices.

12. The Terminal Network Interface of claim 6 further comprising;
an IDE/SATA Interface;
an internal storage device;
wherein said IDE/SATA Interface is used to communicate with an internal storage device and said internal storage device for use to store a large amount of files for use by downstream peripheral devices.

13. The Terminal Network Interface of claim 2 further comprising;
a plurality of USB to video converters;
wherein said USB to video converters are used to generate graphics for display on one or more video display devices.

14. The Terminal Network Interface of claim 3 further comprising;
a plurality of USB to video converters;
wherein said USB to video converters are used to generate graphics for display on one or more video display devices.

15. The Terminal Network Interface of claim 4 further comprising;
a plurality of USB to video converters;
wherein said USB to video converters are used to generate graphics for display on one or more video display devices.

16. The Terminal Network Interface of claim 5 further comprising;
a plurality of USB to video converters;
wherein said USB to video converters are used to generate graphics for display on one or more video display devices.

17. The Terminal Network Interface of claim 7 further comprising;
a plurality of USB to video converters;
wherein said USB to video converters are used to generate graphics for display on one or more video display devices.

18. The Terminal Network Interface of claim 2 further comprising;
at least one PCI Connector;
at least one multiport serial card;
wherein said PCI Connector and said multiport serial card are used to interface with on board serial port expansion cards for communicating with legacy serial devices.

19. The Terminal Network Interface of claim 3 further comprising;
at least one PCI Connector;
at least one multiport serial card;
wherein said PCI Connector and said multiport serial card are used to interface with on board serial port expansion cards for communicating with legacy serial devices.

20. The Terminal Network Interface of claim 4 further comprising;
at least one PCI Connector;
at least one multiport serial card;
wherein said PCI Connector and said multiport serial card are used to interface with on board serial port expansion cards for communicating with legacy serial devices.

21. The Terminal Network Interface of claim 6 further comprising;
at least one PCI Connector;
at least one multiport serial card;
wherein said PCI Connector and said multiport serial card are used to interface with on board serial port expansion cards for communicating with legacy serial devices.

22. The Terminal Network Interface of claim 2 further comprising;
at least one PCI Connector;
a plurality of video cards;
wherein said PCI Connector is used to interface with a plurality of video cards and said plurality of video cards are used to generate graphics for display on one or more video display devices.

23. The Terminal Network Interface of claim 3 further comprising;
at least one PCI Connector;
a plurality of video cards;
wherein said PCI Connector is used to interface with a plurality of video cards and said plurality of video cards are used to generate graphics for display on one or more video display devices.

24. The Terminal Network Interface of claim 7 further comprising;
a Mini PCI Connector;
a wireless adapter card;
wherein said Mini PCI Connector is used to interface to said wireless adapter card.

25. The Terminal Network Interface of claim 2 further comprising;
at least one PCI Connector;
at least one multiport serial card;
an IDE/SATA Interface;
an internal storage device;
wherein said PCI Connector and said multiport serial card are used to interface with on board serial port expansion cards for communicating with legacy serial devices; and said IDE/SATA Interface is used to communicate with an internal storage device and said internal storage device is for use to store a large amount of files for use by downstream peripheral devices.

26. The Terminal Network Interface of claim 2 further comprising;
at least one PCI Connector;
a plurality of video cards;
an IDE/SATA Interface;
an internal storage device;
wherein said PCI Connector is used to interface with a plurality of video cards and said plurality of video cards are used to generate graphics for display on one or more video display devices; and said IDE/SATA Interface is used to communicate with an internal storage device and said internal storage device is for use to store a large amount of files for use by downstream peripheral devices.

27. The Terminal Network Interface of claim 2 further comprising;
a plurality of USB to video converters;
an IDE/SATA Interface;
an internal storage device;
wherein said USB to video converters are used to generate graphics for display on one or more video display devices; and said IDE/SATA Interface is used to communicate with an internal storage device and said internal storage device is for use to store a large amount of files for use by downstream peripheral devices.

28. The Terminal Network Interface of claim 3 further comprising;
at least one PCI Connector;
at least one multiport serial card;
an IDE/SATA Interface;
an internal storage device;
wherein said PCI Connector and said multiport serial card are used to interface with on board serial port expansion cards for communicating with legacy serial devices; and said IDE/SATA Interface is used to communicate with an internal storage device and said internal storage device is for use to store a large amount of files for use by downstream peripheral devices.

29. The Terminal Network Interface of claim 3 further comprising;
at least one PCI Connector;
a plurality of video cards;
an IDE/SATA Interface;
an internal storage device;
wherein said PCI Connector is used to interface with a plurality of video cards and said plurality of video cards are used to generate graphics for display on one or more video display devices; and said IDE/SATA Interface is used to communicate with an internal storage device and said internal storage device is for use to store a large amount of files for use by downstream peripheral devices.

30. The Terminal Network Interface of claim 3 further comprising;
a plurality of USB to video converters;
an IDE/SATA Interface;
an internal storage device;
wherein said USB to video converters are used to generate graphics for display on one or more video display devices; and said IDE/SATA Interface is used to communicate with an internal storage device and said internal storage device is for use to store a large amount of files for use by downstream peripheral devices.

31. The Terminal Network Interface of claim 4 further comprising;
a plurality of USB to video converters;
an IDE/SATA Interface;
an internal storage device;
wherein said USB to video converters are used to generate graphics for display on one or more video display devices; and said IDE/SATA Interface is used to communicate with an internal storage device and said internal storage device is for use to store a large amount of files for use by downstream peripheral devices.

32. The Terminal Network Interface of claim 5 further comprising;
a plurality of USB to video converters;
an IDE/SATA Interface;
an internal storage device;
wherein said USB to video converters are used to generate graphics for display on one or more video display devices; and said IDE/SATA Interface is used to communicate with an internal storage device and said internal storage device is for use to store a large amount of files for use by downstream peripheral devices.

33. The Terminal Network Interface of claim 5 further comprising;
at least one PCI Connector;
a plurality of video cards;
an IDE/SATA Interface;
an internal storage device;
wherein said PCI Connector is used to interface with a plurality of video cards and said plurality of video cards are used to generate graphics for display on one or more video display devices; and said IDE/SATA Interface is used to communicate with an internal storage device and said internal storage device is for use to store a large amount of files for use by downstream peripheral devices.

34. A Method of interfacing information between a peripheral device and a Central Wagering Hub comprising the steps of:
a user entering (or inputting) information (a message) into any one of a plurality of peripheral devices;
said peripheral device transmitting said message to the TNI-2 of claim 1;
said TNI-2 receiving said message;
said TNI-2 inserting an appropriate identifying data field into said message to identify which specific peripheral device the message originated from;
said TNI-2 transmitting the message with the additional identifying data field to the Central Wagering Hub via a TCP/IP network;
said Central Wagering Hub receiving said message;
said Central Wagering Hub processing said message and generating an acknowledgement message;
said Central Wagering Hub transmitting said acknowledgement message, via a TCP/IP Network, to the TNI-2;
said TNI-2 receiving said acknowledgement message
said TNI-2 processing said acknowledgement message and determining from which specific peripheral device the original message originated;
said TNI-2 transmitting said acknowledgement message to the originating peripheral device;
said original peripheral device receiving said acknowledgement message;
said original peripheral device processing the returned data.

35. The Method of claim 34, wherein said message originating from any one or more of a plurality of peripheral devices is a pari-mutuel wagering transaction.

36. A method of transmitting information from a Central Wagering Hub to any one or more of a plurality of peripheral devices comprising the steps of:
a Central Wagering Hub generating a message to be processed by at least one of a plurality of peripheral devices;
said Central Wagering Hub transmitting said message, via a TCP/IP Network, to the TNI-2 of claim 1;
said TNI-2 receiving said message;
said TNI-2 processing said message and determining which specific peripheral device or devices said message is intended for;
said TNI-2 transmitting said message to the intended peripheral device or devices via a communications interface;
said peripheral device or devices receiving said message;
said peripheral device or devices processing said message.

37. The method of claim 36 further comprising the steps of:
said peripheral device or devices generating a response message;
said peripheral device or devices transmitting said response message to the TNI-2 via a communications interface;
said TNI-2 receiving said response message or messages;
said TNI-2 inserting an appropriate identifying data field into said response message or messages to identify which specific peripheral device or devices the message or messages originated from;
said TNI-2 transmitting said response message or messages, with the additional identifying data field, to the Central Wagering Hub via a TCP/IP network;
said Central Wagering Hub receiving said response message or messages;
said Central Wagering Hub processing said response message or messages.

38. The method of claim 34 wherein the peripheral device is a serial device and said communications interface is a RS232/422/485 interface.

39. The method of claim 35 wherein the peripheral device is a serial device and said communications interface is a RS232/422/485 interface.

40. The method of claim 36 wherein the peripheral device is a serial device and said communications interface is a RS232/422/485 interface.

41. The method of claim 37 wherein the peripheral device is a serial device and said communications interface is a RS232/422/485 interface.

42. The method of claim 34 wherein the peripheral device is a TCP/IP peripheral device and said communications interface is an Ethernet network.

43. The method of claim 35 wherein the peripheral device is a TCP/IP peripheral device and said communications interface is an Ethernet network.

44. The method of claim 36 wherein the peripheral device is a TCP/IP peripheral device and said communications interface is an Ethernet network.

45. The method of claim 37 wherein the peripheral device is a TCP/IP peripheral device and said communications interface is an Ethernet network.

46. The method of claim 34 wherein the peripheral device is a TCP/IP peripheral device and said communications interface is a wireless Ethernet network.

47. The method of claim 35 wherein the peripheral device is a TCP/IP peripheral device and said communications interface is a wireless Ethernet network.

48. The method of claim 36 wherein the peripheral device is a TCP/IP peripheral device and said communications interface is a wireless Ethernet network.

49. The method of claim 37 wherein the peripheral device is a TCP/IP peripheral device and said communications interface is a wireless Ethernet network.

50. A method of generating graphics for display on one or more video display devices comprising the steps of:
the Central Wagering Hub generating a message;
said Central Wagering Hub transmitting said video message, via a TCP/IP network, to the TNI-2;
said TNI-2 receiving said transmission of said video message;
said TNI-2 utilizing an internal character generator to process said video message;
said TNI-2 generating a properly formatted video message for display;
said TNI-2 transmitting said properly formatted video message to at least one downstream peripheral video output device;
said downstream peripheral video output device receiving said transmission of said properly formatted video message;
said downstream peripheral video output device processing said properly formatted video message;
said downstream peripheral video output device generating the graphics for display;
said downstream peripheral video output device displaying said graphics.
